(19) United States
(12) Patent Application Publication
(10) Pub. No.: US 2008/0128179 A1
(43) Pub. Date: Jun. 5, 2008

(54) METHOD FOR CONTROLLING INPUT PORTION AND INPUT DEVICE AND ELECTRONIC DEVICE USING THE METHOD

(75) Inventors: Naoki Tatehata, Kyoto (JP); Takefumi Inoue, Nara (JP)

Correspondence Address: PEARNE & GORDON LLP, 1801 EAST 9TH STREET, SUITE 1200, CLEVELAND, OH, 44114-3108, US

(73) Assignee: Matsushita Electric Industrial Co., Ltd., Osaka (JP)

(21) Appl. No.: 11/948,250

(22) Filed: Nov. 30, 2007

(30) Foreign Application Priority Data
Dec. 4, 2006 (JP) 2006-326603

(51) Int. Cl. G06F 3/041

(52) U.S. Cl. 178/18.01

(57) ABSTRACT

A method for controlling an input portion of electronic devices enables the input portion capable of both a coordinate input operation and a pressure input operation to be easy-to-use. The input portion, which includes an operation panel, a coordinate input section disposed thereunder, and a pressure input section disposed thereunder, is connected to a controller so as to form an input device. In the coordinate input operation, the user runs a finger across the operation panel, and in the pressure input operation, the user presses a predetermined position. In the method, the distinction between the two input operations is performed by detecting the shape of the contact part of the finger in contact with the surface of the input portion based on the signal obtained from the coordinate input section and by using the detected result and predetermined criteria. The controller outputs the signal corresponding to the determination.

### BACKGROUND OF THE INVENTION

1. Field of the Invention

The present invention relates to a method for controlling an input portion of electronic devices of various types and to an input device and an electronic device using the method.

2. Background Art

Various electronic devices such as mobile phones have an input device including a push-button input means as an input portion, so that the user can perform the input operation of a telephone number or other information by operating the input device.

The Internet connection environment, which has been greatly improved in recent years, enables the user to browse the Internet using a mobile phone. In line with this, it is necessary to allow the user to move the cursor freely on the display of the mobile phone.

In order to allow the user to perform such an input operation, there have been proposed an input portion having the combination of a coordinate input section and a pressure input section, and an input device using the input portion. The coordinate input section allows the user to move the cursor on the display, and the pressure input section allows the user to perform the input operation of a telephone number or other information.

One such electronic device having the conventional input device is shown in FIG. 9, and the input device is described as follows with reference to FIG. 9.

In FIG. 9, electronic device 101 having the conventional input device includes coordinate input section 102 and pressure-type input section 104 disposed thereunder. Coordinate input section 102 allows the user to perform a coordinate input operation, and pressure-type input section 104 allows the user to perform a pressure input operation from above coordinate input section 102.

In the coordinate input operation, the user runs a finger horizontally across the surface of coordinate input section 102 which can be a capacitive sensor or a similar device. More specifically, when the user runs a finger across the surface of coordinate input section 102, the electrostatic capacitance of the capacitive sensor (unillustrated) in coordinate input section 102 changes according to the position of the finger, which is conductive. The information of the electrostatic capacitance is inputted to an unillustrated controller, which performs a predetermined process to detect the coordinate position.

Pressure-type input section 104 can be formed of switches that change their state when pressed by the user. More specifically, coordinate input section 102 is provided on its main surface with instruction displays 103, and pressure-type input section 104 is provided on its recessed bottom with dome-shaped push-type switches 105 corresponding to instruction displays 103. When the user presses one of instruction displays 103 on coordinate input section 102 to perform a pressure input operation, the pressed instruction display 103 is partly bent so as to press the corresponding one of switches 105. As a result, at least two conductive portions (unillustrated) are electrically connected to each other in the switch so as to execute the pressure input operation.

The conventional input device is formed of coordinate input section 102 and pressure-type input section 104 which together compose the input portion, and a controller. When the user performs a coordinate input operation or a pressure input operation in the conventional input device, display 106 displays the data related to the operation.

One of the prior arts related to the present invention is disclosed in Japanese Patent Unexamined Publication No. 2002-123363.

In the conventional input device, the user performs a pressure input operation by pressing instruction displays 103 on coordinate input section 102, in other words, by pressing instruction displays 103 and the switches disposed thereunder at the same time. This sometimes causes the coordinate input operation to be performed and the coordinate information is inputted when the user intends to perform the pressure input operation. Therefore, it is necessary for the user to switch between the two input operations in order to select a desired input mode. It is possible to switch between the two input operations by additionally providing a selector switch; however, this makes it necessary for the user to operate the selector switch. As a result, the number of components is increased and the operability is deteriorated.

To solve this problem, in the conventional input device, the switching between the two input operations is processed by software, for example, as follows. It is determined whether the finger of the user is in contact with the surface of coordinate input section 102 over a predetermined time period, or it is determined whether the contact position of the finger has moved across the surface or not.

However, the determination as to whether the finger contact is maintained for the predetermined time period results in a time lag during the input, thus deteriorating the operability of the input device. On the other hand, the movement of the contact position of the finger is sometimes confused with the pressure input operation, causing an operational error and hence making the operability of the input device insufficient.

### SUMMARY OF THE INVENTION

In view of the conventional problems, it is an object of the present invention to provide a method for controlling an input portion capable of reliably distinguishing between a pressure input operation and a coordinate input operation so as to be easy-to-use, and also to provide an input device and an electronic device which use the method.

The method and the devices according to the present invention have the following structures.

The method according to the present invention uses an input portion capable of a coordinate input operation and a pressure input operation. The user performs the coordinate input operation by running a finger horizontally across the surface of the input portion and performs the pressure input operation by pressing a predetermined position within the coordinate input region with a finger. When the user operates the input portion, a signal based on the coordinate input operation and a signal based on the pressure input operation are controlled by software so as not to be outputted at the same time. Which of the two signals is to be outputted is determined from the shape of the contact part of a finger in contact with the surface of the input portion and from predetermined criteria, and then the selected signal is outputted. The shape of the contact part of the finger is detected based on the signal obtained from the coordinate input operation. This method can distinguish between the two input operations by how the user touches the input device with a finger, making the input portion easy-to-use.

The coordinate input operation may be based on the change in electrostatic capacitance due to the movement of the finger across the surface of the input portion. This makes it possible to detect the coordinates of two or more positions at the same time or to detect the distribution of the coordinates, thereby reducing the constraints to determine the operating state, that is, which of the two input operations the user is performing.

The determination as to which of the signals to be outputted may be based on the area of the contact part of the finger. The operating state is determined based on the contact area of the finger, which is determined by how the user touches the input portion with the finger.

The determination as to which of the signals to be outputted may be based on the number of the contact part of the finger or the characteristic contour of the contact part. The operating state is determined based on the number of the contact part of the finger or the characteristic contour of the contact part, which is determined by how the user touches the input portion with the finger.

The determination as to which of the signals to be outputted may be based on the contact part having the largest area of the contact parts of the fingers. This can reduce the constraints to determine the operating state when two or more fingers are in contact with the surface of the input portion because the determination as to which of the signals to be outputted is based on contact part of the finger having the largest area.

The signal based on the coordinate input operation may not be outputted for a predetermined time period after the user performs the pressure input operation. This prevents an unintended input operation when the user successively performs the pressure input operation.

The input device of the present invention implements the method for controlling the input portion of the present invention. The input device is provided with a controller to perform the determination of the operating state and to output a signal corresponding to the determined operating state. The input device can be treated as a unit component which performs both the determination as to which of the two signals to be outputted and the output of the determined signal.

The electronic device of the present invention implements the method for controlling the input portion of the present invention. The electronic device is provided with a display to display letters and graphics. The display allows the user to visually recognize which of the coordinate input operation and the pressure input operation has been determined to be valid when the user operates the input portion. This allows the user to visually check whether the determined input operation is what he/she intends to perform and to continue the input operation while monitoring the display, making the electronic device easy-to-use.

As described hereinbefore, the present invention provides a method for controlling an input portion capable of both the coordinate input operation and the pressure input operation so as to be easy-to-use, and also provides an input device and an electronic device which use the method.

### BRIEF DESCRIPTION OF THE DRAWINGS

FIG. 1 is a schematic diagram of an input device according to a first embodiment of the present invention.

FIG. 2A is a diagram showing an operating state that is determined to be a pressure input operation based on the criteria to switch between the two input methods in the input device.

FIG. 2B is a diagram showing an operating state that is determined to be a coordinate input operation based on the same criteria as FIG. 2A.

FIG. 3A is a diagram showing an operating state that is determined to be a pressure input operation based on the criteria to switch between the two input methods in an input device according to a second embodiment.

FIG. 3B is a diagram showing an operating state that is determined to be a coordinate input operation based on the same criteria as FIG. 3A.

FIG. 4 is a diagram showing an operating state that is determined to be a coordinate input operation based on the criteria to switch between the two input methods in an input device according to a third embodiment.

FIG. 5A is a diagram showing an operating state that is determined to be a pressure input operation based on the criteria to switch between the two input methods in an input device according to a fourth embodiment.

FIG. 5B is a diagram showing an operating state that is determined to be a coordinate input operation based on the same criteria as FIG. 5A.

FIG. 6 is a front view of a mobile phone as an embodiment of an electronic device according to a fifth embodiment of the present invention, the electronic device using as a numeric keypad an input device having an input portion.

FIG. 7 is a schematic view showing the numeric keypad to which the user has made an operation.

FIG. 8A is a block diagram of an electronic device using an input device according to a sixth embodiment of the present invention.

FIG. 8B is a block diagram of an electronic device in which the input device contains a controller.

FIG. 9 is a partially exploded view of an electronic device using a conventional input device.

### DETAILED DESCRIPTION OF THE INVENTION

Embodiments of the present invention are described as follows.

### First Embodiment

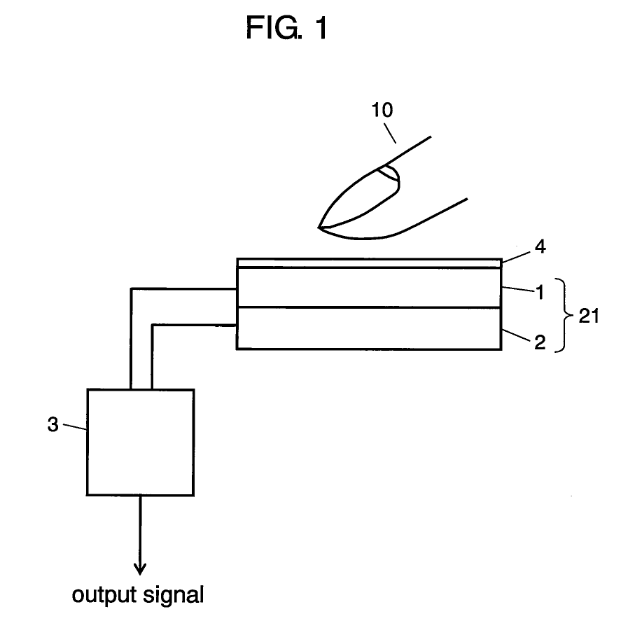

FIG. 1 is a schematic diagram of an input device implementing the method for controlling an input portion according to a first embodiment of the present invention.

As shown in FIG. 1, the input device of the present first embodiment includes input portion 21 having coordinate input section 1 and pressure input section 2 disposed thereunder. Coordinate input section 1 has a sheet-like structure and is either disposed beneath the entire area of operation panel 4 or integrated therewith. The input device of the present embodiment is formed of input portion 21 and controller 3, which is described later.

Coordinate input section 1 is formed of a capacitive sensor, which detects the contact of finger 10 of the user with operation panel 4 and receives the position coordinate. Using the capacitive sensor not only contributes to the thickness reduction of the input portion, but also makes it possible to detect the coordinates of two or more positions at the same time or to detect the distribution of the coordinates. This has the advantage of reducing the constraints to determine the later-described operating state.

Pressure input section 2, on the other hand, is formed of switches that can be pressed by the user from above operation panel 4 via coordinate input section 1. Operation panel 4 is formed of adjacently arranged elastic plates so that it can be partially bent together with coordinate input section 1 when the user presses thereon to perform a pressure input operation. Operation panel 4 can be, for example, a resin on which instruction displays such as letters are displayed.

The user performs the coordinate input operation in coordinate input section 1 by running finger 10 horizontally across the surface of operation panel 4. Running finger 10 horizontally across the surface of operation panel 4 changes the electrostatic capacitance between the electrodes in the capacitive sensor according to the position of finger 10 because it is conductive. The information of the electrostatic capacitance is read by a controlling unit or the like having the function of calculating the coordinate position and is then subjected to a predetermined process to detect the coordinate position. In the present embodiment, controller 3 shown in FIG. 1 is provided with this function.

Although not illustrated in detail, the switches of pressure input section 2 are the same push-type mechanical switches as those used in the conventional example. When the user performs a pressure input operation from above operation panel 4 using finger 10, the switch corresponding to the position selected by the user can be changed in state. Note that the number of the switches is not limited. Pressure input section 2 can be formed of a plurality of switches arranged at predetermined intervals so that the user can press them individually; be formed of a single switch; or have other structure.

Controller 3 is formed of a microcomputer which receives a coordinate input signal from coordinate input section 1 and a pressure input signal from pressure input section 2. Controller 3 processes these signals and outputs the signal corresponding to the processed result. The outputted signal is used to perform the predetermined function of an electronic device such as a mobile phone, a personal computer, or a music player.

In the input device of the present first embodiment, controller determines the operating state of the input portion and then controls, by software, the signal based on the coordinate input operation and the signal based on the pressure input operation so as not to be outputted at the same time. Which of the two signals is to be outputted is determined based on the signal obtained from coordinate input section 1.

Which of the signals is to be outputted is determined from the shape of the contact part of finger 10 in contact with operation panel 4 based on the signal obtained from coordinate input section 1. The term “shape” used in this application means size (area), characteristic contour, or their combination. The signal to be outputted is determined from these elements based on predetermined criteria.

The criteria as to which signal is to be outputted is, for example, whether or not fingers 10 are spaced from each other.

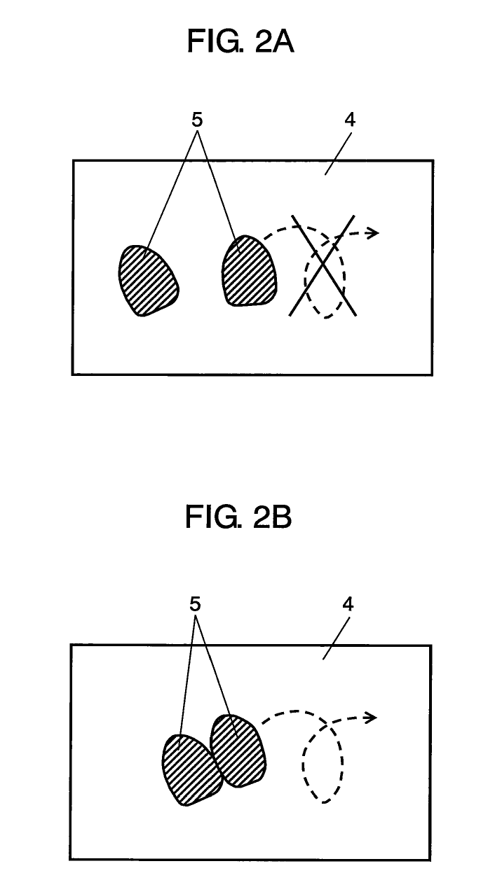

This case is described as follows with reference to FIG. 2.

FIG. 2A is a diagram showing an operating state that is determined to be a pressure input operation based on the criteria to switch between the two input methods in the input device according to the first embodiment of the present invention. FIG. 2B is a diagram showing an operating state that is determined to be a coordinate input operation based on the same criteria as FIG. 2A. Two fingers 10 are spaced from each other and in contact with the input portion in FIG. 2A, and are closely attached to each other and in contact with the input portion in FIG. 2B.

According to the criteria in the present first embodiment, when fingers 10 are spaced from each other as in FIG. 2A, it is determined that the user is performing a pressure input operation, and when two or more fingers 10 are closely attached to each other as shown in FIG. 2B, it is determined that the user is performing a coordinate input operation.

In other words, when the user touches operation panel 4 with fingers 10 spaced from each other with the intention of performing a pressure input operation, the signal obtained from coordinate input section 1 produces the state of FIG. 2A where fingers 10 spaced from each other are detected from more than one position. Controller 3 determines based on the detected result that this is a pressure input operation. In contrast, when the user touches operation panel 4 with two or more fingers 10 closely attached to each other with the intention of performing a coordinate input operation, the signal obtained from coordinate input section 1 produces the state of FIG. 2B where two or more fingers 10 closely attached to each other are detected. Controller 3 determines that this is a coordinate input operation.

As described above, whether the user is performing a coordinate input operation or a pressure input operation can be determined simply by checking whether fingers 10 in contact with the input portion are attached to or spaced from each other. This facilitates the switching between the two input methods, making it unnecessary to additionally provide a selector switch. Furthermore, this can prevent a time lag which occurs, for example, when it is determined whether finger 10 is in contact with operation panel 4 for a predetermined time period. In addition, this can reduce operational errors due to insufficient distinction between the coordinate input operation and the pressure input operation as in the conventional method of determining whether the contact position has moved across the surface of the input portion or not. These advantageous features improve the operability in switching between the two input methods, making the input device easier-to-use than the conventional devices.

How accurately the shape of the contact part of finger 10 in contact with the surface of the input portion has been reproduced as contact portion 5 after being detected by the capacitive sensor is determined by the position resolution, sensitivity and the like of the sensor. This indicates that the sensor should be selected according to the criteria as to which signal is to be outputted.

In the above description, the operating state can be identified by checking whether or not fingers 10 are closely attached to each other, and the operating state can be easily calculated from the contact area of fingers 10 or the like. Since the state in which the user runs two fingers 10 closely attached to each other across operation panel 4 is determined to be a coordinate input operation, the calculation is applied to the portion having the largest area of the contact parts of fingers 10 closely attached to each other. This reduces the other constraints and hence facilitates the process of distinguishing between the two input operations.

When performing a pressure input operation, the user presses somewhere in the predetermined region of operation panel 4. In the first embodiment, when pressure input section 2 has a plurality of switches, it is preferable that push-type switches arranged adjacent to each other in the region are designed to be pressed individually. The size (projected area) of the switches in this case can be determined by the size of the input portion, the size of the finger of the user, and the like. For example, in the case of a mobile phone, the size of the switches can be determined according to the area of the tip of a single finger 10 pressed against a flat surface. More specifically, one switch can have a projected area smaller than 100 mm² and larger than 10 mm², and more preferably between 20 to 50 mm² so as to improve the operability, allocative efficiency, and other properties.

The push-type switches are usually pressed with a single finger 10. Therefore, it does not cause any problem to determine that the operation with two or more fingers 10 closely attached to each other is a coordinate input operation. This allows the user to naturally operate the pressure input operation.

In the aforementioned description, the criteria to distinguish between the two input operations is whether two or more fingers 10 are closely attached to or spaced from each other. Alternatively, the distinction between the two input operations can be based on the other criteria.

The following is a description of the criteria based on the number of fingers 10 closely attached to each other.

### Second Embodiment

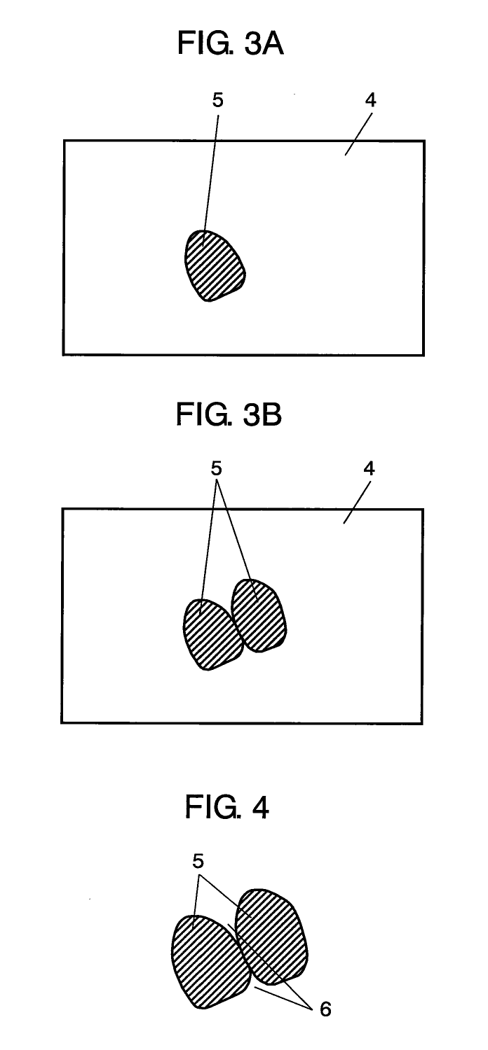

FIG. 3A is a diagram showing an operating state that is determined to be a pressure input operation based on the criteria to switch between the two input methods in an input device according to a second embodiment of the present invention. FIG. 3B is a diagram showing an operating state that is determined to be a coordinate input operation based on the same criteria as FIG. 3A. One finger 10 is in contact with the input portion in FIG. 3A, and two fingers 10 are closely attached to each other and in contact with the input portion in FIG. 3B.

In the second and subsequent embodiments, the input portion has the same structure as in the first embodiment and only the determination criteria of controller 3 differ from those in the first embodiment. The selection criteria of the capacitive sensor to be mounted on the input device and the size of the switches are identical to those in the first embodiment so that the description thereof is omitted.

In the present second embodiment, the determination criteria are the difference in the contact area of finger 10. For example, the reference area is set to an area intermediate between the area shown in FIG. 3A where a single finger 10 is in contact with the input portion and the area shown in FIG. 3B where two fingers 10 closely attached to each other are in contact with the input portion. When the detected area is smaller than the reference area, controller 3 is prevented from outputting the signal based on the coordinate input operation and it is determined that the user is performing a pressure input operation.

According to the above determination criteria, the contact area shown in FIG. 3A is determined to be smaller than the reference area, so that the signal based on the coordinate input operation is not outputted when the user runs finger 10 across operation panel 4. On the other hand, the contact area shown in FIG. 3B is determined to be larger than the reference area, so that the signal based on the coordinate input operation is outputted when the user runs finger 10 across operation panel 4. In this manner, the determination criteria allow the coordinate input operation and the pressure input operation to be much better distinguished from each other than in the conventional devices.

Other alternative determination criteria are the characteristic contour of finger 10, which is described as follows with reference to FIG. 4.

### Third Embodiment

In the present third embodiment, the input portion has the same structure as in the first embodiment, and only the determination criteria of controller 3 differ from those in the first embodiment. The description of the common parts is omitted.

FIG. 4 is a diagram showing an operating state that is determined to be a coordinate input operation based on the criteria to switch between the two input methods in an input device according to a third embodiment of the present invention. In FIG. 4, two fingers 10 closely attached to each other as in FIG. 3B are shown as contact portion 5 detected by the sensor.

When two fingers 10 closely attached to each other are in contact with the input portion as shown in FIG. 4, the contour of contact portion 5 has two gaps 6. From the detection of gaps 6, it is determined that two or more fingers 10 closely attached to each other are in contact with the input portion.

More specifically, when the curved contour has an inward protrusion, it is determined that two or more fingers 10 closely attached to each other are in contact with the input portion. Alternatively, the same determination as above can be made from whether the contour has a singular point of a function or not. This is because, in FIG. 4, the contour has large inward protrusions at gaps 6 that can be detected as a singular point of a function. As a result, this can be determined to be the contact of two or more fingers 10 closely attached to each other with the input portion.

As described hereinbefore, the contact of a single finger 10 with the input portion and the contact of two or more fingers 10 with the input portion can be distinguished based on both the determination criteria of the second embodiment described with FIG. 3 and those of the third embodiment described with FIG. 4. Both the determination criteria can be used to distinguish between the coordinate input operation and the pressure input operation so as to provide an input device with high operability.

Other alternative determination criteria are described as follows.

### Fourth Embodiment

In the present fourth embodiment, the input portion has the same structure as in the first to third embodiments, and only the determination criteria of controller 3 differ from those in the first to third embodiments. The description of the common parts is omitted.

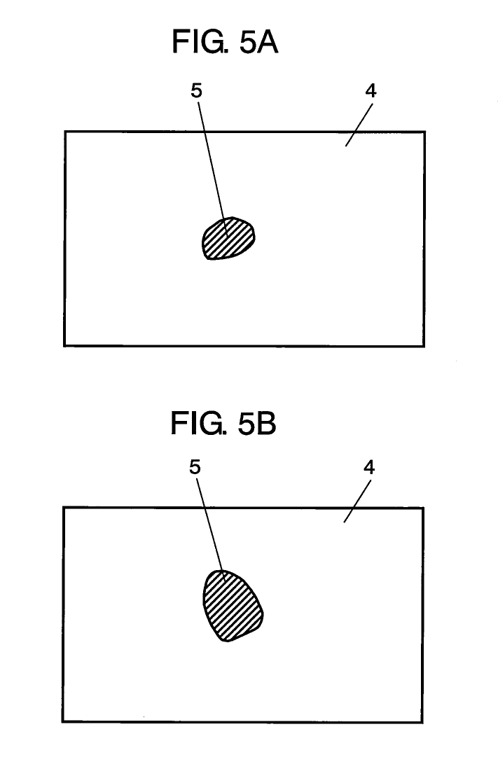

FIG. 5A is a diagram showing an operating state that is determined to be a pressure input operation based on the criteria to switch between the two input methods in an input device according to a fourth embodiment of the present invention. FIG. 5B is a diagram showing an operating state that is determined to be a coordinate input operation based on the same criteria as FIG. 5A. The difference in the area of contact portion 5 of finger 10 is schematically shown in FIGS. 5A and 5B. The contact area is larger in FIG. 5B than in FIG. 5A.

In the present embodiment, the reference area is set to an area intermediate between the area shown in FIG. 5A and the area shown in FIG. 5B. When contact portion 5 is smaller than the reference area, the signal based on the coordinate input operation is not outputted.

The contact area shown in FIG. 5A is determined to be smaller than the reference area, so that controller 3 does not output the signal based on the coordinate input operation when the user urns finger 10 across operation panel 4. On the other hand, the contact area shown in FIG. 5B is determined to be larger than the reference area, so that controller 3 outputs the signal based on the coordinate input operation when the user runs finger 10 across operation panel 4.

As described above, the reference area is preferably in the range of 10 to 100 mm², and particularly in the range of 20 to 50 mm², in view of the size of regular push-type switches. The reference area of this range is nearly as large as the switches so as to have a value close to the contact area of finger 10 in the pressing operation. As a result, it does not cause any problem to determine the contact shown in FIG. 5A to be a pressure input operation.

Under the determination criteria, the coordinate input operation and the pressure input operation can be distinguished more efficiently than in the conventional devices when the user performs these operations with a single finger 10. The aforementioned range of the reference area is determined on the assumption that the user uses any of four fingers 10 other than a thumb.

When the range of the reference area is determined on the assumption that the user may use a thumb having a larger contact area than the fingers, the reference area can be in the range of 10 to 120 mm², and more preferably 20 to 60 mm².

Besides the aforementioned determination algorithm, the area, contour, size, and so on of finger 10 can be used to distinguish between the two input operations. Preferable among them are the difference in area of finger 10 and the characteristic contour of finger 10 because they are comparatively easy to be applied. It is also possible to combine them in order to improve the determination accuracy.

As described above, in the present invention, the two input methods are switched by how the user touches the input device with a finger, enabling the input portion to be easy-to-use and to have high operability. Furthermore, it becomes possible to prevent a time lag which often occurs during the input and deteriorates the operability in the conventional devices. It also becomes possible to reduce operational errors due to insufficient distinction between the coordinate input operation and the pressure input operation.

It is preferable to prevent controller 3 from outputting the signal based on the coordinate input operation for a predetermined time period after the user operates the pressure input operation. This is because an unintended input operation can be prevented with high precision when the user successively performs the pressure input operation. The predetermined time period is preferably 0.1 seconds or more, and more preferably 0.2 seconds or more to make the user feel comfortable when he/she continuously hits the keys. However, when it is too long, the predetermined time period makes the user feel that the operability is not enough. Therefore, it is preferably 1 second or less, and more preferably 0.5 seconds or less.

The following is a description of a case where the electronic device using the input portion is applied to a mobile phone.

### Fifth Embodiment

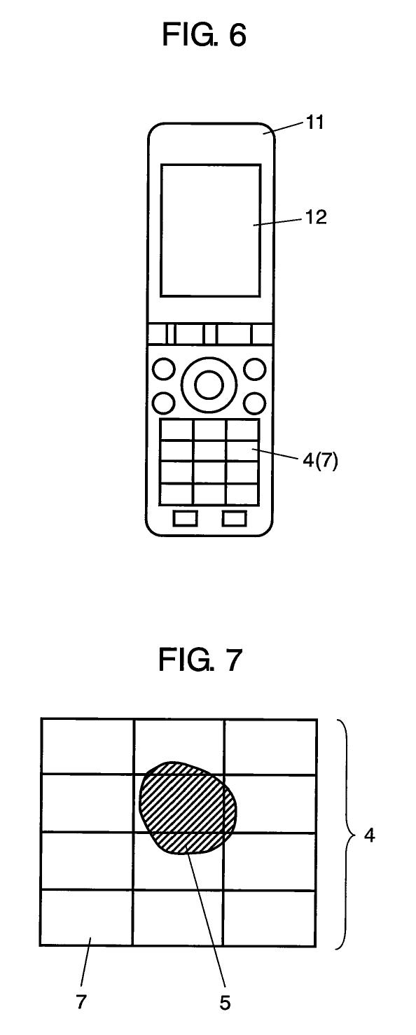

FIG. 6 is a front view of a mobile phone as an embodiment of an electronic device of the present invention. The mobile phone has as numeric keypad 7 an input device having the input portion according to the first to fourth embodiments. FIG. 7 is a schematic view showing numeric keypad 7 to which the user has made an operation.

As shown in FIG. 6, mobile phone 11 is formed of a lower housing having numeric keypad 7 and the like on its surface and an upper housing having display 12 on its surface. Display 12 shows the letters and graphics necessary for the operations, so that the user can visually recognize telephone numbers, data for music and games, a list of the grouped data, icons for command input, and the like.

In mobile phone 11, numeric keypad 7 functions as the input device. More specifically, the upper surface of numeric keypad 7 is formed of operation panel 4 under which coordinate input section 1 and pressure input section 2 (both unillustrated) are disposed and individually connected to controller 3 (unillustrated). The fundamental operation and the criteria to determine the input state of the input device having controller 3 are not described again because they have been described in detail previously with reference to FIGS. 1 to 5.

Operation panel 4 is provided thereon with buttons each having an outwardly curved surface and arranged in a three by four array in order to facilitate the input of figures when the user operates numeric keypad 7. The user can press any of the buttons in order to perform a pressure input operation. Pressure input section 2 in mobile phone 11 is formed of 12 switches arranged in a three by four array. Coordinate input section 1 has an area enough to cover the entire area of numeric keypad 7.

When the electronic device is mobile phone 11, the user is likely to perform the coordinate input operation with a thumb. Therefore, it is preferable that controller 3 uses the determination criteria described in the fourth embodiment with reference to FIG. 5. The determination criteria can distinguish between the coordinate input operation and the pressure input operation when the user performs them with a single finger 10. When the distinction between the two input operations is based on the contact area of finger 10 including the thumb, the reference area is preferably in the range of 10 to 120 mm², and particularly 20 to 60 mm² because these values are close to the contact area of the thumb in the pressing operation.

Assuming that the user performs a pressing operation with fingernails, it is likely that the user touches two or more positions of the input portion at the same time. In that case, the area of each position is measured, and contact portion 5 having an area of 10 mm² or less is ignored when it is within 5 mm of the edge of contact portion 5 having an area of 10 mm² or more.

Display 12 shows the output of the signal indicating which of the coordinate input operation and the pressure input operation has been determined to be valid. This allows the user to continue the input operation while monitoring the display on display 12, making the input device easier-to-use.

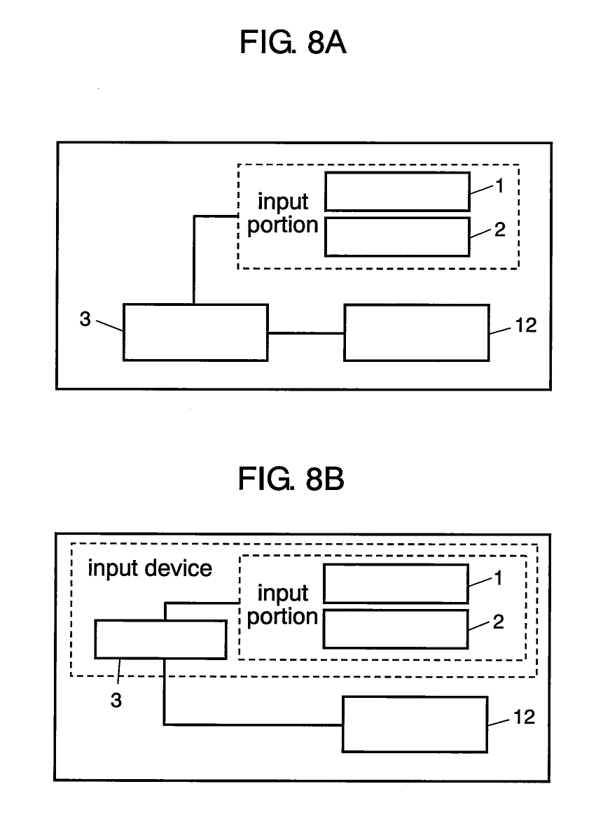

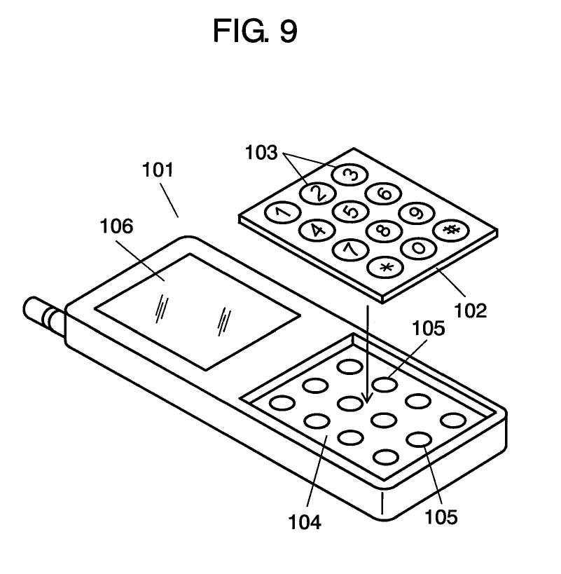

In the input device of the present invention, the input portion and controller 3 can be separated from or integrated with each other. The structure of the electronic device using the input device formed of the input portion and controller 3 separated from each other is shown in the block diagram of FIG. 8A. The structure of the electronic device using the input device formed of the input portion and controller 3 integrated with each other is shown in the block diagram of FIG. 8B.

The input device containing controller 3 as shown in FIG. 8B can be treated as a so-called unit component which performs both the determination of the signal to be outputted and the output of the determined signal. This makes the input device useful for both component manufacturers and device manufacturers using the components. On the other hand, the input device shown in FIG. 8A has the advantage of capable of using a single unit as both the controlling unit formed, for example, of a microcomputer for the function control of the electronic device and as controller 3. In this manner, the structures shown in FIGS. 8A and 8B have advantages of their own and can be selected according to the need.

According to the method for controlling an input portion and an input device and an electronic device using the method according to the present invention, the input portion capable of both the coordinate input operation and the pressure input operation can be easy-to-use and useful in forming the input operation portion of various electronic devices.

What is claimed is:

1. A method for controlling an input portion capable of a coordinate input operation and a pressure input operation, the coordinate input operation being performed by the user by horizontally moving finger, and the pressure input operation being performed by the user by pressing a predetermined position in a coordinate input region, the method comprising:
controlling a signal based on the coordinate input operation and a signal based on the pressure input operation so as not to be outputted at a same time when the user operates the input portion;
detecting a shape of a contact part of a finger in contact with a surface of the input portion based on the signal obtained from the coordinate input section; and
determining which of the signal based on the coordinate input operation and the signal based on the pressure input operation is to be outputted, and then outputting the determined signal, the determination being based on the detected result and predetermined criteria.

2. The method for controlling the input portion of claim 1, wherein
the coordinate input operation is based on a change in electrostatic capacitance due to the movement of the finger.

3. The method for controlling the input portion of claim 1, wherein
the determination is based on an area of the contact part of the finger.

4. The method for controlling the input portion of claim 1, wherein
the determination is based on the number of the contact part of the finger or a characteristic contour of the contact part.

5. The method for controlling the input portion of claim 3, wherein
the determination is based on the contact part having a largest area of the contact parts of the fingers.

6. The method for controlling the input portion of claim 1, wherein
the signal based on the coordinate input operation is not outputted for a predetermined time period after the user performs the pressure input operation.

7. An input device implementing the method for controlling the input portion of any one of claims 1 to 6, the input device comprising:
a controller for performing the determination, thereby outputting one of the signal based on the coordinate input operation and the signal based on the pressure input operation.

8. An electronic device for implementing the method for controlling the input portion of any one of claims 1 to 6, the electronic device comprising:
a display for displaying letters and graphics, the display allowing the user to visually recognize which of the coordinate input operation and the pressure input operation has been determined to be valid when the user operates the input portion.
